(19) United States
(12) Patent Application Publication
(10) Pub. No.: US 2005/0286753 A1
(43) Pub. Date: Dec. 29, 2005

(54) Automated inspection systems and methods

(75) Inventor: Alan Ho, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Triant Technologies Inc., Vancouver (CA)

(21) Appl. No.: 10/875,187

(22) Filed: Jun. 25, 2004

(51) Int. Cl. G06K 9/00; H04N 17/00

(52) U.S. Cl. 382/141; 348/180

(57) ABSTRACT

An automatic defect detection system may be applied to detecting defects in electronic displays. The system acquires an image of a display being tested and generates test vectors from the image. Each test vector has a spatial part and a characteristic part. The test vectors are compared to a set of representative reference vectors. A poor match to any of the representative reference vectors indicates a possible defect.

### TECHNICAL FIELD

The invention relates to inspecting manufactured objects. Some embodiments of the invention have application in testing electronic displays such as LCD displays, other flat panel displays, CRT displays and the like. Some embodiments of the invention perform defect classification as well as defect detection.

### BACKGROUND

An example of a problem which this invention addresses is the automatic detection of defects in displays such as computer displays, television screens or the like. The problem of automatically identifying defects in displays is complicated by the fact that there are over 400 categories of defects that may affect an electronic display, such as an LCD screen. Further, yields are typically quite high so that some noticeable defects occur only relatively rarely.

Even tiny variations in manufacturing a display may have undesirable visible effects on the display. The human eye is very sensitive to subtle variations in color and intensity. Quality control procedures used in manufacturing high quality displays must be able to detect flaws which would make the display unacceptable to a user. However, it is currently impossible to make a machine which replicates the subtleties of human perception. Existing automatic inspection systems are often not sufficiently sensitive to detect visible defects. Display manufacturing facilities often use expert human inspectors to check the quality of manufactured displays.

The problem of automatically testing displays for visible defects is compounded by the fact that even a perfect display can have different appearances from different angles of view and under different lighting conditions.

Visual inspection technology has used a variety of image analysis techniques including statistical methods, image transformations/convolutions, and automatic learning techniques to enhance fault detection and classification. For example, Hawthorne et al., U.S. Pat. No. 5,917,935 entitled Mura detection apparatus and method describes methods which involve acquiring an image with a Mura defect, and performing a Laplacian convolution on the image to enhance the Mura defect against background illumination.

Statistical methods as described in Pouijavid, U.S. Pat. No. 6,381,374 entitled Histogram analysis method for defective pixel identification have also been proposed. Poutjavid describes a method in which pixel color signals are analyzed to identify mean and standard deviation values from a histogram of the pixel population. Pixels lying outside of a desired range, such as a distribution envelope determined from the histogram, are compared to the mean value plus or minus a multiple of the standard deviation. Pixels lying outside of the desired range are labeled or masked as potentially defective.

Automatic learning techniques have also been used to further improve defect detection. The concepts neural networks, fuzzy logic, and similarity have been applied to visual inspection technology. Cho et al., A Comparison of Rule-based, K-Nearest Neighbor, and Neural Net Classifiers for Automated Inspection, 1991, Proceedings, Developing and Managing Expert System Programs. pp. 202-209 describes a method to locate surface defects on wood. Toth et al. Improved minimum distance classification with Gaussian outlier detection for industrial inspection IEEE, 11th International Conference on Image Analysis and Processing Sep. 26-28, 2001 Palermo, Italy describes several different types of method based on similarity calculations that are used detect defects in compact disks.

The problem of detecting faults in electronic displays is different from defect detection in wood and compact disks because the items under inspection are electronic display pixels. The fault characteristics for pixels are often unknown and subjective to the human eye, making classification of a fault extremely difficult. In addition, electronic displays contain a high “pixel count” which in turn leads high computational requirements for classification.

There is a need for reliable visual inspection systems capable of inspecting manufactured items such as electronic displays including computer displays, televisions, displays for electronic equipment and the like.

### SUMMARY OF THE INVENTION

This invention provides methods, apparatus, and computer media for use in quality assurance and other testing of objects such as electronic displays.

One aspect of the invention provides a method for detecting defects in electronic displays. The method comprises providing image data for a test display and a set of reference vectors. The reference vectors are generated from reference image data of one or more reference displays known to be good. The image data comprises values for one or more characteristics of the test display as a function of spatial position on the test display. The method generates from the image data a plurality of test vectors. Each of the test vectors has a spatial part corresponding to a spatial position on the test display and a characteristic part. For each of the test vectors, the method: identifies a subset of the set of reference vectors based upon at least the spatial part of the test vector; and determines a degree of similarity between the test vector and one or more reference vectors of the subset of the set of reference vectors. The method identifies any of the test vectors for which the degree of similarity fails to satisfy a similarity criterion.

Some embodiments of the invention use clustering to reduce the number of reference vectors to which each test vector is compared.

Another aspect of the invention provides a method for detecting defects in electronic displays. The method comprises providing image data for a test display and a set of reference vectors. The image data comprises values for one or more characteristics of the test display as a function of spatial position on the test display. The reference vectors are generated from reference image data of one or more reference displays known to be good. The method generates from the image data a plurality of test vectors, each of the test vectors having a spatial part corresponding to a spatial position on the test display and a characteristic part. For each of the test vectors the method: based upon at least the spatial part of the test vector, identifies a cluster associated with a subset of the set of reference vectors; and, subsequently, based upon both the spatial and characteristic parts of the test vector, identifies within the subset of the reference vectors a number, k, of nearest-neighbor reference vectors. The method determines a degree of similarity between the test vector and the nearest-neighbor reference vectors and identifies any of the test vectors for which the degree of similarity fails to satisfy a similarity criterion.

Another aspect of the invention provides a method for detecting defects in electronic displays. The method comprises: providing image data for a test display and a set of reference vectors. The image data comprises values for one or more characteristics of the test display as a function of spatial position on the test display. The reference vectors are generated from reference image data of one or more reference displays known to be good. The method generates from the image data a plurality of test vectors. For each of the test vectors the method determines a degree of similarity between the test vector and a vector derived from one or more reference vectors of the set of reference vectors based upon a distance between the test and reference vectors according to a metric. The metric is defined at least in part by a statistical property of the set of reference vectors. The statistical property may comprise a measure of variance of a component of the reference vectors. The measure of variance may comprise a range, standard deviation or the like.

Another aspect of the invention provides a computer readable medium carrying instructions which, when executed by a data processor, cause the data processor to perform a method according to the invention.

Other aspects of the invention relate to apparatus for testing of displays or other objects. In some embodiments the apparatus comprises a data processor programmed to implement a method of the invention.

For example, one apparatus-related aspect of the invention provides apparatus for automatic detection of defects in electronic displays. The apparatus comprises a data processor; and, a data store accessible to the data processor and capable of storing image data for a test display. The image data comprises values for one or more characteristics of the test display as a function of spatial position on the test display. The data store is also capable of holding a set of reference vectors generated from reference image data of one or more reference displays known to be good. The data store may be distributed. Parts of the data store may comprise data storage devices of heterogeneous types. The apparatus includes a program memory containing software instructions. The software instructions cause the data processor to: retrieve from the data store image data for a test display; generate from the image data a plurality of test vectors, each of the test vectors having a spatial part corresponding to a spatial position on the test display and a characteristic part; for each of the test vectors: identify a subset of the set of reference vectors based upon at least the spatial part of the test vector; and, determine a degree of similarity between the test vector and one or more reference vectors of the subset of the set of reference vectors; and, identify any of the test vectors for which the degree of similarity fails to satisfy a similarity criterion.

Another apparatus-related aspect of the invention provides aapparatus for automatic detection of defects in electronic displays. The apparatus comprises imaging means for obtaining image data for a test display, the image data comprising values for one or more characteristics of the test display as a function of spatial position on the test display; reference vector storage means providing a set of reference vectors generated from reference image data of one or more reference displays known to be good; test vector generating means for generating from image data for a test display a plurality of test vectors, each of the test vectors having a spatial part corresponding to a spatial position on the test display and a characteristic part; reference vector selecting means for identifying a subset of the set of reference vectors corresponding to a test vector generated by the test vector generating means based upon at least the spatial part of the test vector; and, vector comparison means for determining a degree of similarity between a test vector and one or more reference vectors of the subset of the set of reference vectors identified by the reference vector selecting means; and, means for identifying any of the test vectors for which the degree of similarity determined by the vector comparison means fails to satisfy a similarity criterion.

Further aspects of the invention and features of specific embodiments of the invention are described below.

### BRIEF DESCRIPTION OF THE DRAWINGS

In drawings which illustrate non-limiting embodiments of the invention,

FIG. 1 is a schematic view of an inspection system according to an embodiment of the invention;

FIG. 2 is a block diagram of a visual inspection system according to one embodiment of the invention;

FIG. 3 is a flow chart which illustrates a method for identifying defects according to the invention;

FIG. 4 is a flow chart which illustrates a method for building a set of representative reference vectors;

FIG. 4A is a flow chart which illustrates a method for selecting a representative subset of a set of reference vectors;

FIG. 4B is a matrix which may be used in the method of FIG. 4A;

FIG. 4C is a flow chart which illustrates an alternative method for selecting a representative subset of a set of reference vectors;

FIG. 5 is a method for identifying a set of nearest-neighbor vectors;

FIG. 6 is a schematic view illustrating how an image may be broken up into areas for clustering;

FIG. 6A is a schematic view illustrating possible sources of reference vectors for a cluster of test vectors;

FIG. 6B is a schematic view illustrating an alternative embodiment of the invention having overlapping areas;

FIG. 6C is a schematic view illustrating an example screen display which may be used in an embodiment of the invention wherein clustering is performed using both spatial and pixel color; and,

FIG. 7 is a flow chart illustrating a method for determining a health index.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

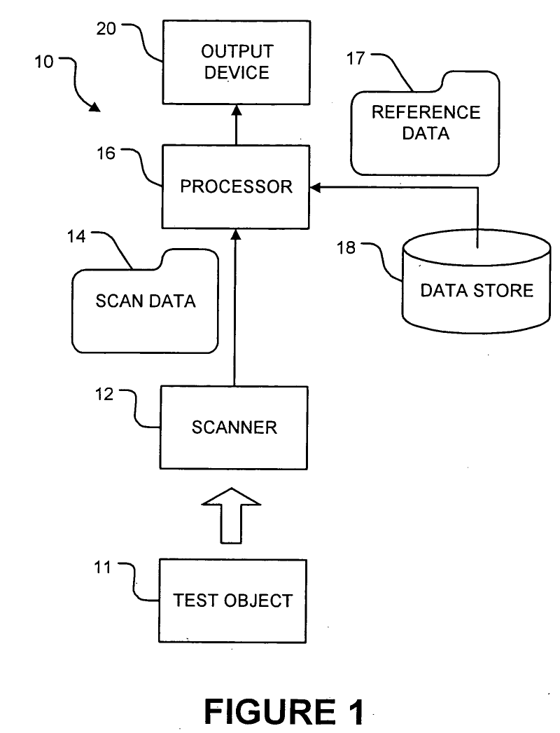

This invention relates to automatic defect detection. FIG. 1 shows schematically a system 10 according to the invention. System 10 includes a scanner 12 for scanning a test object 11. Scanner 12 is a scanner capable of sensing a characteristic of test object 11 as a function of position on the test object. A digital camera is used for scanner 12 in specific embodiments of the invention.

Scanner 12 scans a test object 14 to yield scan data 14. Scan data 14 indicates some characteristic or characteristics of test object 12 as a function of position in a two or three dimensional scan area. Scan data 14 is provided to a processor 16. Processor 16 uses scan data 14 and reference data 17 from a data store 18 to identify defects in test object 11 as described below.

Processor 16 may comprise any suitable data processing system. For example, processor 16 may comprise a general purpose computer having one or more CPUs. Data store 18 may comprise any suitable data storage system accessible to processor 16 for example, data store 18 may comprise a disk drive, random access memory, or the like.

Processor 16 controls an output device 20 to take or initiate some action in response to detecting defects in test object 11. The action taken or initiated may include one or more actions such as:
indicating a PASS or FAIL result;
displaying a map of identified defects;
maintaining statistics about detected defects;
controlling a manufacturing process;
sorting test objects; or the like.

One application of the invention is in detecting defects in electronic displays, such as LCD, CRT or plasma displays for computers, television displays, displays for devices such as personal digital assistants, cellular telephones, and the like. The invention will be illustrated with reference to a system for the automatic testing of computer displays. Those skilled in the art will understand that the principles of operation of such a system can be applied to systems for testing for defects in other products.

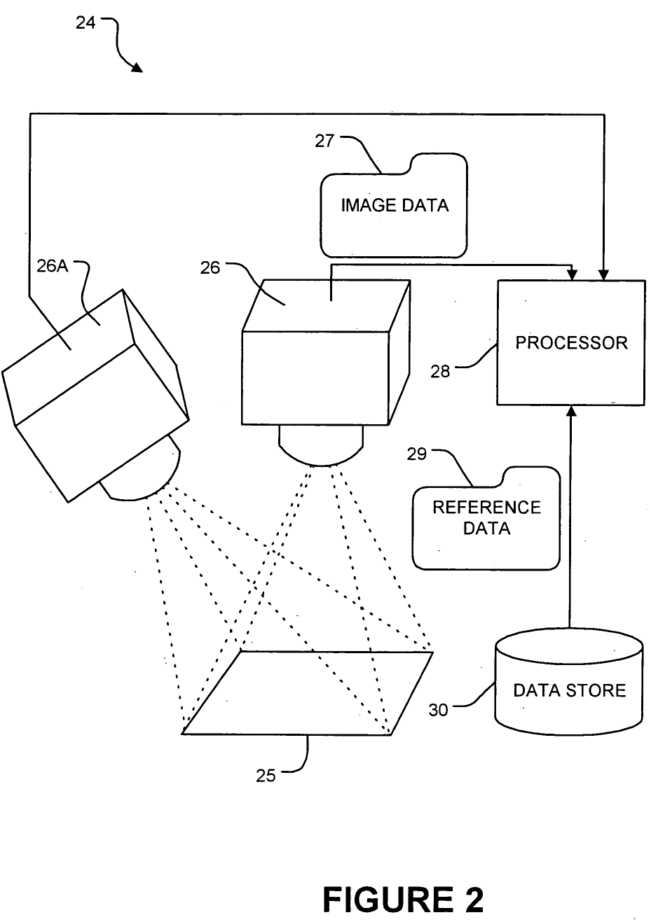

FIG. 2 shows a system 24 for testing computer displays 25. System 24 has a digital camera 26 which images a display 25 which is being tested. The display is controlled to display a desired image while the digital camera acquires its image of the display. In some embodiments of the invention the display is controlled to display a uniform image in which all pixels of the display are set to the same color and brightness. In some embodiments, all pixels of display 25 are set to display maximum, or other predetermined, values of each color (for example, red, green and blue).

Image data 27 from camera 26 is delivered to a processor 28. Processor 28 processes the image data using reference data 29 from a data store 30. Reference data 29 is derived from one or more images of displays which have a known condition (for example, good). Some example ways to obtain reference data 29 are described below. Camera 26 typically includes an array of light sensors, such as a CCD array, and produces an image which includes one or more output values for each of a large number of pixels which make up an image of the object (such as a display) being viewed by camera 26. The number of pixels in the image data is determined by the resolution of camera 26 and not by the resolution or size of display 25. In general, display 25 and the CCD or other image acquisition array of camera 26 may have different numbers of pixels. Camera 26 preferably has a color resolution of at least 8 bits per color channel, preferably at least 12 bits per color channel.

The appearance of a computer display may vary with angle. In some embodiments of the invention, system 24 includes one or more additional cameras 26A which view display 25 from different angles. Where such additional cameras 26A are present, image data from cameras 26A is provided to processor 28.

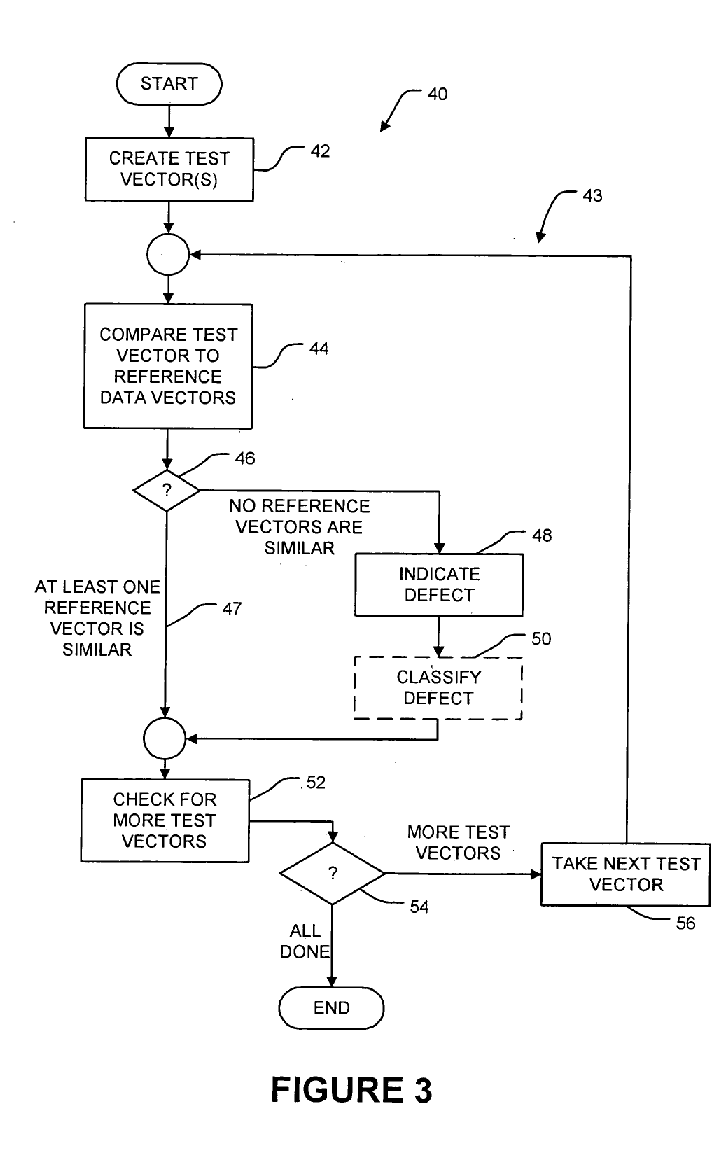

FIG. 3 illustrates a method 40 for processing image data 27 to identify defects in display 25. Method 40 begins by creating test vectors (block 42) based upon image data 27. Each test vector includes position information and information about one or more characteristics of the display being tested which correspond to the position. In the following example, the image data comprises RGB (red, green, and blue) values for each pixel in an image acquired by digital camera 26. In this example, a test vector is created for each pixel. Each test vector V may be represented, for example, as V=[X,Y,R,G,B] where X and Y are x and y coordinates which specify the location of the pixel in the image and R, G and B are respectively the intensities of red, green and blue light detected for the pixel by digital camera 26. In this example, X and Y are spatial components and R, G and B are characteristic components. The vector has a spatial part, which includes the spatial components, and a characteristic part, which includes the characteristic components.

In preferred embodiments of the invention the image data comprises data for each pixel in an array of contiguous pixels and a test vector is generated for each pixel of the image data. As noted below, the test vector for one pixel may include information about characteristics of neighboring pixels in addition to information about characteristics of the pixel to which the test vector corresponds. It is not necessary that the spatial resolution of the image data be the same as the resolution of the display 26 being tested.

A loop 43 which follows block 42 is performed for each test vector. In block 44, the test vector is compared to a set of “good” reference vectors. The comparison may comprise computing a “distance” between the test vector and each of the reference vectors using a suitable metric. If the test vector is similar to at least one of the reference vectors then method 40 branches to path 47 at block 46. In this case, the term “similar” means that the computed distance between the test vector and at least one of the reference vectors (or a function thereof) is less than a threshold amount. As described below, a health index may be computed for each of the test vectors. The health index indicates whether or not the test vector likely results from a defect.

Any suitable metric may be used to implement the invention. Preferably, the metric assigns different weights to the different components of the vectors being compared. If we represent a component of vector V as V_{i,} where i is an integer index which identifies the component of the vector then the metric may be of the form:

$$S = {\sum }_{i} {f}_{i} ( {W}_{i} , Δ {V}_{i} ) \qquad ( 1 )$$

where: S is the distance measure, fᵢ is a function used for comparing the i^{th} components of the test and reference vectors, Wᵢ is a weighting factor for the i^{th} component, and ΔVᵢ is the difference between the values of the i^{th} components of the test vector and the reference vector to which it is being compared. The functions fᵢ may be, but are not necessarily the same for each component.

For example, some possible metrics are:

$$\begin{matrix}S = {\sum }_{i} {W}_{i} ( Δ {V}_{i}^{2} ) & ( 2 ) \\ S = {\sum }_{i} {W}_{i} \vert Δ {V}_{i} \vert & ( 3 ) \\ S = {\sum }_{i} {W}_{i} g ( Δ {V}_{i}^{2} ) & ( 4 ) \\ S = {\sum }_{i} {W}_{i} g ( \vert Δ {V}_{i} \vert ) & ( 5 )\end{matrix}$$

Preferably, the weighting factors, Wᵢ, depend upon the degree of variation in the component in question within the reference vectors. Those components which tend to vary greatly among the “good” reference vectors can advantageously be weighted less heavily than those components which have a smaller variation in the reference vectors.

Some example measures of variation upon which suitable weighing factors may be based include:
the variance, σ²;
the standard deviation, σ;
the range;
similar variance measures; and,
functions of one or more of these variance measures.
   The population for which the measure of variation is calculated may, for example, include all or a subset of the reference vectors.

Since the x and y coordinates of each vector are known and are strongly correlated to the characteristic components (e.g. R, G and B values), it is generally desirable to weigh the components in the spatial part of the vectors being compared somewhat more heavily than other components. If very large relative weight(s) are given to the spatial components then only those reference vectors which are very close spatially to the test vector can be “close” to the test vector according to the distance calculation conversely, giving the spatial components lower weights opens the possibility that reference vectors which are farther spatially from the test vector could still be “close” to the test vector according to the distance calculation. Defect detection systems according to some embodiments of the invention permit adjusting the relative weights given to the spatial and characteristic parts of the vectors to fine tune their operation.

If the test vector is not similar to any of the reference vectors then method 40 branches to block 48 which records that a defect has been detected. In block 49, which is optional, the defect is classified. Method 40 then proceeds to block 52 which determines whether all of the test vectors have been processed. If so, method 40 branches at block 54 and ends. Otherwise, method 40 proceeds to block 56, which selects the next test vector, and proceeds to process the next test vector.

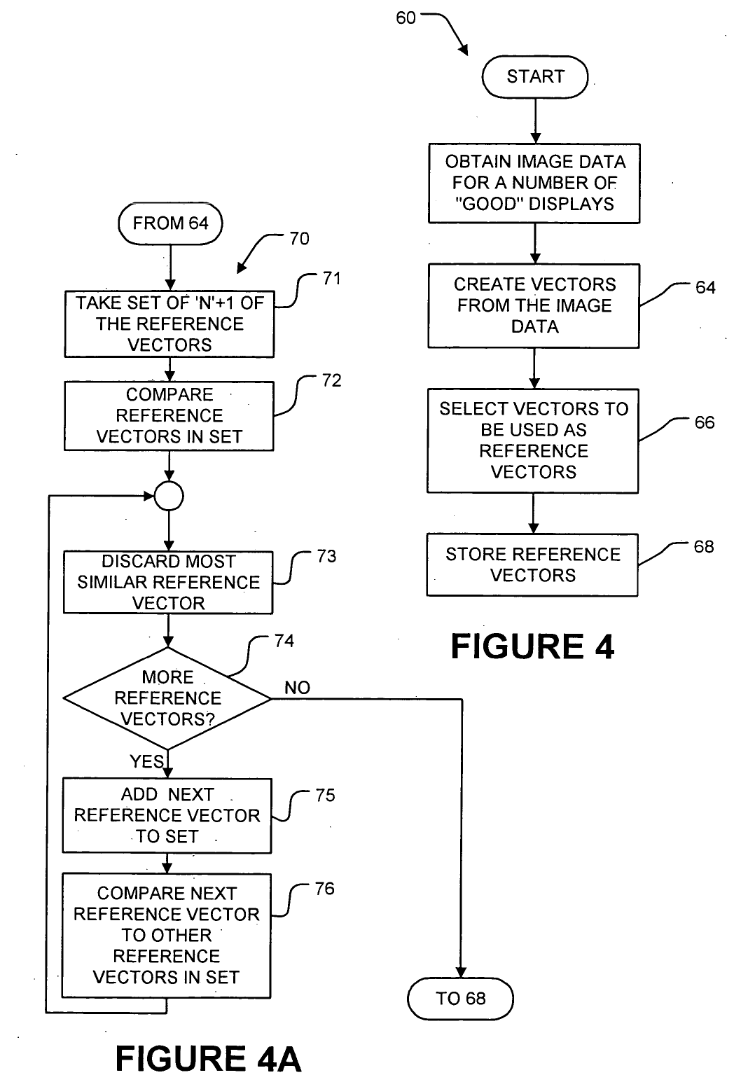

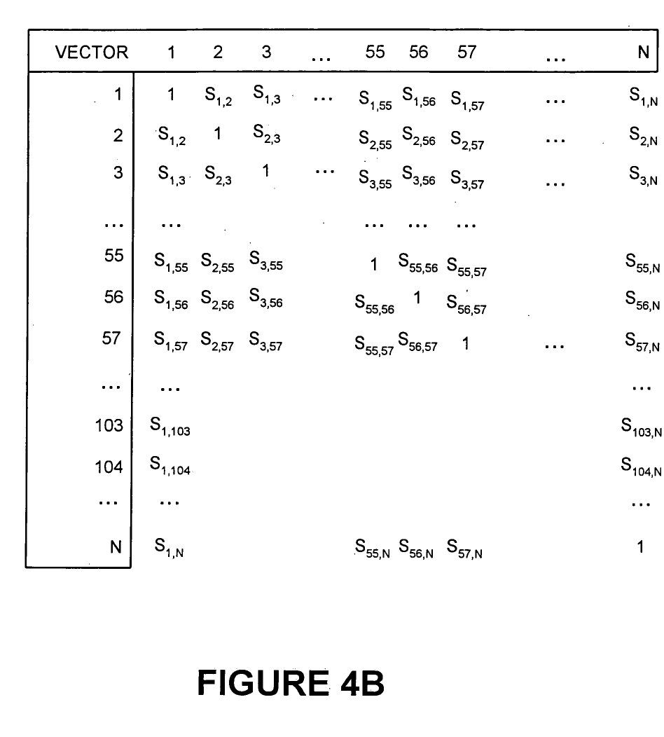

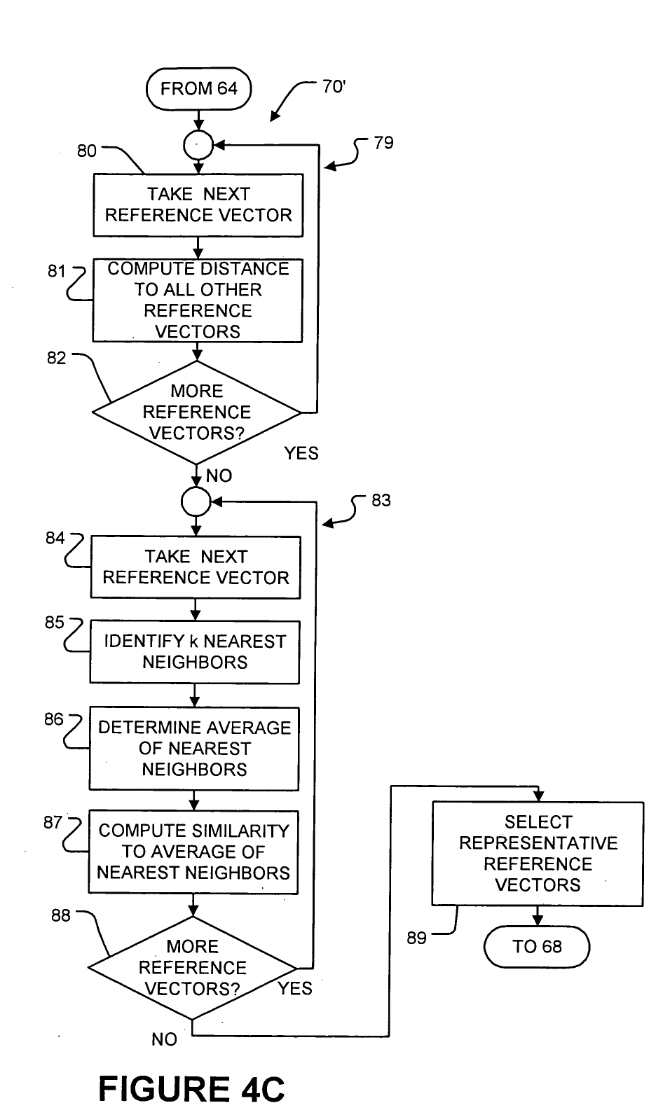

A set of reference vectors may be established by, for example, method 60 of FIG. 4. Method 60 begins in block 62 by using system 24 to obtain reference image data for a number of reference displays known to be “good”. For example, reference image data could be obtained for several displays which have been inspected by expert human inspectors and determined to be “good”. Reference vectors are created from the reference image data in block 64. Each of the reference vectors may be created in the same manner as test vectors are created, as described above. The reference vectors contain the same components as the test vectors to be used in method 40.

The set of reference vectors produced by block 64 could be used directly as reference vectors in method 40 however, there are typically a large number of reference vectors produced by block 64. For example, if each image of camera 26 has approximately 2 Megapixels and images of 15 known good displays are used to create the reference data set then block 64 will produce roughly 30 million vectors.

Block 66 selects a representative subset of the reference vectors produced by block 64. The representative subset contains reference vectors that represent the diversity of vectors in the set of vectors produced by block 64. The selected reference vectors are stored in a data store 30 from which they can be accessed by a processor performing method 40.

FIG. 4A illustrates a method 70 which is used to implement block 66 in some embodiments of the invention. Method 70 begins in block 71 by selecting from the available reference vectors a set of N+1 reference vectors. The selection may be random, in the sequence that the reference vectors were acquired or stored, or based on any suitable criteria. The number N is the number of reference vectors which it is desired to select. Where clustering is used, as described below, N may be a relatively small number, for example a few hundred to a few thousand. N might be 500, for example.

In block 72, each of the reference vectors in the set is compared to the other reference vectors in the set. The result may be represented as a matrix which is symmetrical about its diagonal and has elements Sᵢⱼ where Sᵢⱼ is the similarity between the i^{th} and j^{th} vectors in the set. Typically Sᵢⱼ=Sⱼᵢ. FIG. 4B shows an example matrix.

Block 73 identifies the two distinct vectors in the set having the greatest similarity to one another and discards one of the two distinct vectors. Identifying one of the two distinct vectors to discard may be performed by discarding the one of the two distinct vectors which has the greatest similarity to the vector in the set of reference vectors to which it is second most similar.

For example, consider the case where S_{3,56} is larger than any other value off of the diagonal of the matrix of FIG. 4B. Block 73 will discard one of the 3^{rd} and 56^{th} vectors. To determine which of these vectors to discard, method 70 may find and compare to one another the similarity values which are next smaller to S_{3,56} in each of the third row and 56^{th} column of the matrix. If the next smaller similarity value of the third row is greater than that of the 56^{th} column then the 3^{rd} vector is discarded from the set of reference vectors. If the next smaller similarity value of the third row is less than that of the 56^{th} column then the 56^{th} vector is discarded from the set. In the case of a tie, one of the vectors may be chosen randomly, on the basis of a third-highest similarity between the two distinct vectors or the like.

In block 74 it is determined whether there are any further potential reference vectors to consider. If not, method 70 ends. If there are more reference vectors for consideration then the next reference vector is added to the set in block 75 and the similarity of the next reference vector to each of the other N reference vectors in the set is determined at block 76. Method 70 then loops back to execute block 73 with the newly constituted set.

FIG. 4C illustrates a method 70′ which is used to implement block 66 in some alternative embodiments of the invention. Method 70′ begins by iterating a process 79 which compares each of the reference vectors to all of the other reference vectors according to a suitable distance metric. The distance metric used for selecting the representative reference vectors can conveniently be the same distance metric used to compare a test vector to the representative reference vectors. This is not necessarily the case, however. Process 79 involves selecting a one of the reference vectors to be processed next (block 80);

computing a distance from the selected reference vector to each other reference vector (block 81); and determining whether there are more reference vectors to process (block 82). Process 79 continues until all of the reference vectors have been processed (as determined by a “NO” result from block 82).

The distances determined in process 79 are used in a process 83 which determines how similar each of the reference vectors is to an average of its nearest neighbors. In the illustrated embodiment, process 83 begins by selecting one of the reference vectors to be processed next (block 84) and identifying k nearest neighbors for the selected reference vector in block 85. k is an integer. k is typically a fairly small number, such as a number which is less than 100. In some embodiments, k is in the range of 2-25, preferably in the range of 2-10. k may be the same for each of the reference vectors. As described below, it can be advantageous to allow different values of k for different reference vectors.

Block 86 determines a vector which is an average of the nearest neighbors of the selected vector. The average may be computed in any suitable manner. For example, each component of the average vector may be computed by summing corresponding components of all of the nearest-neighbor vectors and dividing the result by k.

Block 87 computes a similarity between the selected vector and the average vector. Process 83 continues until block 88 determines that block 87 has been performed for all of the reference vectors (as indicated by a “NO” result in block 88).

Finally, method 70 selects as representative reference vectors a subset of the reference vectors which includes those reference vectors identified in block 89 as having the smallest degrees of similarity to the averages of their nearest neighbors. The exact number of representative reference vectors is not particularly important in method 40. The number of reference vectors selected in block 89 may be some suitable predetermined fixed number N. In the alternative, block 89 may select as representative reference vectors all reference vectors for which the distance between the reference vector and the average of the reference vector's k nearest neighbors is greater than some suitable threshold.

As noted above, it is not necessary that k be the same for all of the reference vectors processed in method 70. In some embodiments of the invention k is varied dynamically. In some such embodiments, only those reference vectors for which the distance between the selected reference vector and the neighboring reference vector to which it is being compared is less than a threshold are used as nearest-neighbor vectors.

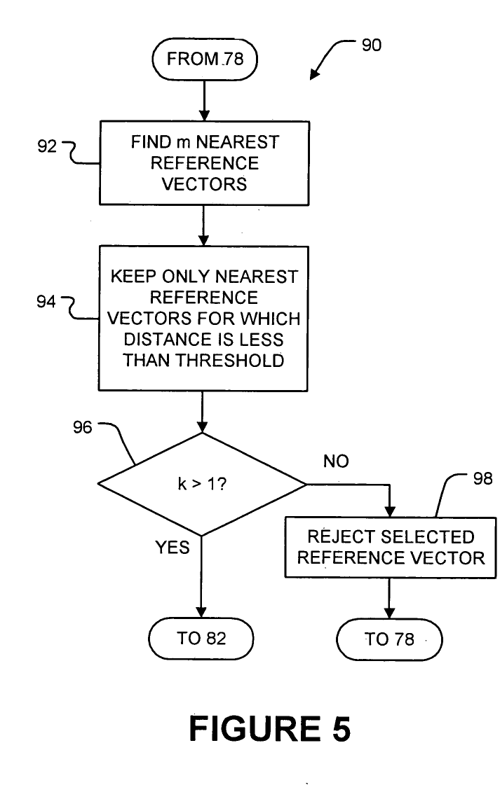

Method 90 of FIG. 5 is an illustration of one method for identifying k nearest-neighbor reference vectors for a selected reference vector. Method 90 begins by identifying those m other reference vectors which are closest to the selected reference vector (i.e. the m other reference vectors for which the distances to the selected reference vector according to the metric being used are the smallest) (block 92). m is an integer representing the largest desired value for k. In block 94 only those of the vectors identified in block 92 which have distances to the selected reference vector which are smaller than the threshold are retained as the k nearest-neighbor vectors.

If, after block 94 is completed, there are more reference vectors remaining as nearest-neighbors of the selected reference vector than a threshold (as indicated by a “YES” result at block 96) then processing continues at block 86 (FIG. 4A). On the other hand, if the number of reference vectors which remain as nearest-neighbors of the selected reference vector is equal to or less than the threshold then the selected reference vector is rejected at block 98 and processing continues at block 84 (FIG. 4A). The threshold applied in block 96 is preferably 1.

Method 90 and other similar methods are advantageous in that they tend to reject any “outliers” from being included in the representative reference set.

Establishing a set of representative reference vectors does not need to be repeated each time a display is tested. The volume of calculations required to establish a near-optimal set of representative reference vectors can be very large, however. It is desirable to reduce the volume of computations used to practice the invention. One way to reduce the volume of computations is to not compute distances between vectors in cases where the result of the computation is unlikely to be important. For example, in process 70 of FIG. 4A, reference vectors having X and Y values corresponding to locations which are physically far apart from one another are highly unlikely to be nearest neighbors. Method 70 may be optimized to compute similarities only between pairs of reference vectors which are physically close to one another (for example, pairs of reference vectors for which (Δx²+Δy²) is less than some threshold or pairs of reference vectors for which both Δx and Δy are less than some threshold).

Clustering is another way to reduce unnecessary computation. In embodiments of the invention which use clustering, the test vectors are separated into a number of clusters. The clusters may be defined spatially, with reference to one or more characteristics, or both spatially and with reference to one or more characteristics.

When the clusters are defined spatially, each cluster includes test vectors corresponding to a contiguous range of physical locations (e.g. to an area of a display 26 being checked). It is convenient but not necessary for all of the clusters to be the same size and shape. A separate set of representative reference vectors is generated for each cluster.

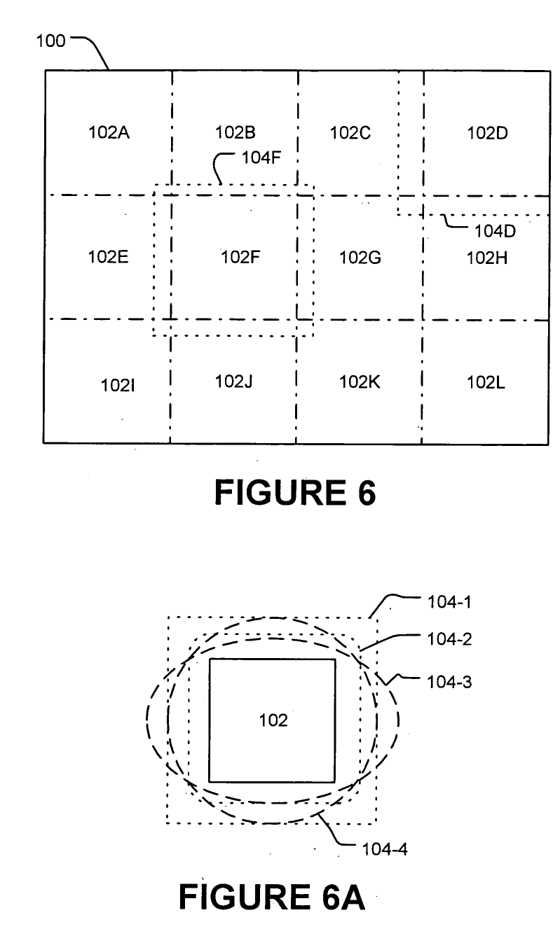

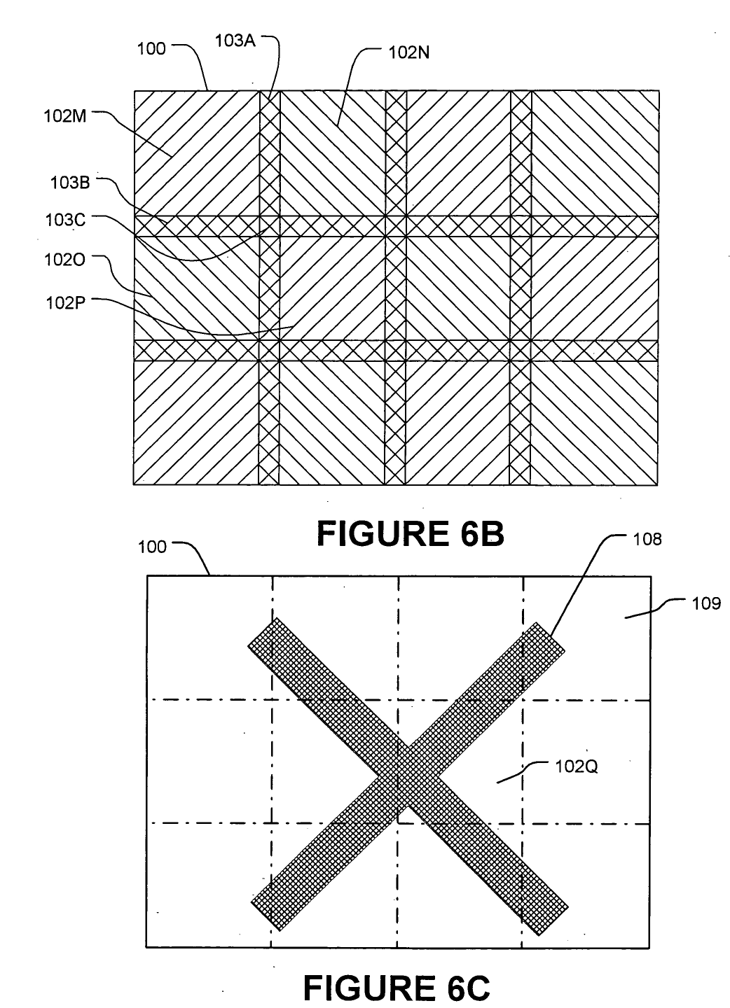

For example, FIG. 6 illustrates one possible way to divide an image 100 of a display 26 into regions 102A through 102L (collectively regions 102). Each cluster includes those test vectors having X, Y values corresponding to the same one of regions 102. The reference vectors to which the test vectors are compared may be selected as described above. The reference vectors to which the test vectors for a cluster are compared are selected from those reference vectors which correspond to a region 104 of the image. Region 104 is somewhat larger than, and includes, the region 102 to which the cluster corresponds. For example, FIG. 6 shows a region 104D corresponding to region 102D and a region 104F corresponding to region 102F.

Regions 104 do not necessarily have the same shapes as regions 102. For example, FIG. 6A shows some possible alternative shapes for the regions 104 from which reference vectors for the cluster corresponding to a region 102 may be selected. Region 104-1 is rectangular (square in the illustrated example). Region 104-2 is rectangular with rounded corners (square with rounded corners in the illustrated example). Region 104-3 is elliptical. Region 104-4 is circular.

In other embodiments of the invention, test vectors of each cluster are compared to reference vectors corresponding to multiple regions 104. The multiple regions 104 cover the region 102 corresponding to the cluster and also cover regions of the image adjacent to region 102. In some such embodiments, regions 104 and 102 are the same. Test pixels of the cluster corresponding to a particular region 102 are compared to a set of reference vectors which is the union of the representative reference vectors corresponding to the particular region 102 and representative reference vectors corresponding to adjacent regions 102.

In other non-preferred embodiments of the invention, regions 104 and 102 are the same but are defined so they overlap with adjacent regions as shown for example, in FIG. 6B. FIG. 6B shows an image of a display 100. The image is divided into a number of regions 102. Regions 102 overlap with adjacent regions 102 in overlap regions 103. For example, the illustrated region 102M overlaps with adjacent region 102N in a strip-like overlap region 103A and with adjacent region 102O in strip-like overlap region 103B. Four illustrated regions 102M, 102N, 102O, and 102P all overlap in a rectangular overlap region 103C.

In the embodiment of the invention illustrated by FIG. 6B, a pixel located in an overlap region 103 is a member of the clusters corresponding to all of the regions 102 which overlap at the location of the pixel. To ensure that pixels at or near to the boundaries of regions 102 are matched to the closest reference vectors, values for the “health” of pixels which belong to more than one overlapping cluster should be selected to be the best of the health values determined for each of the clusters.

Clustering may also be performed with reference to another characteristic, such as pixel color, either on its own or in conjunction with spatial position. For example, FIG. 6C shows an image of a display which is being controlled to display a two-color pattern made up of regions 108 of a first color on a background 109 of a second color. In the embodiment illustrated by FIG. 6B, vectors are clustered both by the physical location of the pixel on which they are based and on the color of the pixel. For example, pixels in region 102Q would belong to one of two clusters depending upon whether they had color 108 or background color 109. Clustering based upon a characteristic, such as color, can be used in systems configured to perform tests in which a display is configured to display one or more specific images.

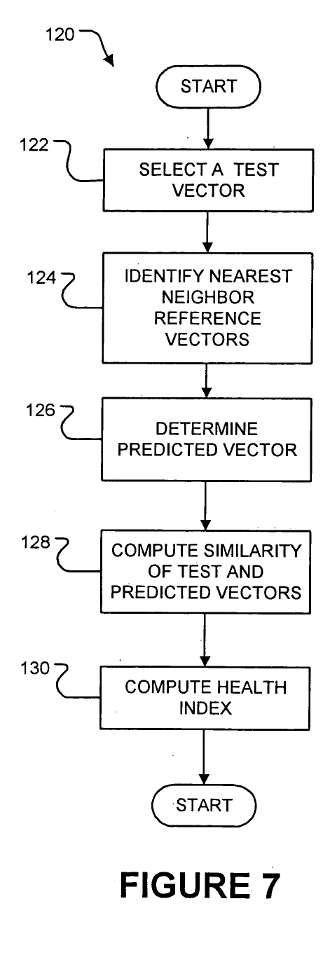

Some embodiments of the invention compute a health index for each of the test vectors. The health index is an indicator of how likely it is that the test vector results from a defect. In some embodiments of the invention the health index for a test vector is computed by a method 120 as illustrated in FIG. 7. Method 120 begins in block 122 by selecting a test vector or which a health index is to be computed. Block 124 identifies those of the representative reference vectors which are nearest neighbors of the test vector and selects the k nearest neighbors. The identification and selection of a set of k nearest neighbors may be performed substantially as described above. The value(s) of k used in establishing a health index can be different from the values(s) of k, if any, used in the selection of representative reference vectors.

In block 126 a predicted vector is obtained by taking an average, which may be a weighted average, of the k nearest-neighbor reference vectors. Block 128 computes a measure of the similarity of the selected test vector and the predicted vector of block 126. The measure of similarity may be, for example, a distance between the selected test vector and the predicted vector or a function of such a distance.

The metric used in computing the measure of similarity on which the health index is based does not need to be the same as the metric used to identify the reference vectors which are nearest neighbors of the test vector. It can be advantageous to weight the different components of the vectors differently when computing a health index. In the computation of the health index, those characteristics which are most important to the quality of the display being tested can be weighted most heavily.

For example, cellular telephone screens need to be visible in a wide range of lighting conditions, even sunny conditions but are not typically used for graphic design or other applications requiring perfect color fidelity. A system for testing cellular telephone screens may weight characteristics such as pixel brightness and contrast most highly. As another example, a plasma screen television display should be viewable from a wide range of angles. A system for testing such displays might weight relatively heavily a characteristic indicative of consistent RGB color values through a wide range of angles.

In block 130 a health index is computed from the similarity measure of block 128. The health index may be based in part upon an average similarity of the reference vectors in the representative reference vector set and a measure of the variance of the similarities of the reference vectors in the set of representative reference vectors. The average similarity, SSM, may be determined, for example, by computing a measure of similarity between every pair of reference vectors in the set of representative reference vectors and averaging the results. The measure of variance may, for example, comprise a variance, range or standard deviation of the results.

In one embodiment of the invention, a health index, SH, is given by:

$$\begin{matrix}SH = \frac{SSim - SSM}{1 - SSM} when SSim > SSM \\ and by \text{:} & ( 6 ) \\ SH = \frac{SSim - SSM}{SStd} when SSim \leq SSM & ( 7 )\end{matrix}$$

In equations (6) and (7) SSim is the measure of similarity between the selected test vector and the predicted vector; SSM is the average similarity of the test vectors which has been normalized so that 0<SSM≦1; and SStd is the standard deviation of the similarities of the representative reference vectors. Equation (6) produces a health index which has a positive value for all cases where SSim>SSM. In these cases it is unlikely that the test vector indicates a defect. Equation (7) produces a health index which has a negative value for cases where SSim<SSM. In these cases it is possible that the test vector indicates a defect.

A system health index may be used in various ways. For example, alarms may be triggered on the occurrence of one or more of:
the health index is below a low level threshold;
the health index is above a high level threshold;
a characteristic component of a test vector has a value which differs by more than a threshold value from the corresponding value in the predicted vector; or
the like.
   A map may be generated which shows the system health index as a function of physical location. The pixels in the map may be colored or have a brightness according to the system health index so that defective pixels identified by the system can be readily found on the display being tested.

A system according to the invention may be tuned for accuracy by refining the set of reference vectors to which test vectors are compared. For example, suppose a system according to the invention is found to falsely fail (e.g. identify as being “bad”) some displays which human experts agree should pass. Such displays may be called “false negatives”. In this case, image data for the false negatives may be added to the set of “good” displays from which reference vectors are generated and a new set of representative reference vectors can be generated. The system can then be made to use the new set of representative reference vectors. Since that new set includes at least some of the false negatives, the system should no longer fail the false negatives. Generating a new set of reference vectors can be performed off line without interrupting the operation of the system.

Other adjustments that can be made to fine tune the operation of a system according to the invention include:
the number of representative reference vectors selected;
the maximum value for k (i.e. the maximum number of nearest neighbors identified for each vector in computations involving nearest-neighbors;
a maximum distance(s) (spatial, according to one or more metrics, or both) that one vector can be away from another and still be considered to be a nearest neighbor of the other vector;
the metric used to compute distances between different vectors (or equivalently, the measure of similarity between different vectors used to compare the different vectors) or the weighting factors used in the metric;
the set of characteristics selected for inclusion in the test and reference vectors;
the various thresholds which may be used in the comparison of different vectors; and,
the function(s) used as the health index.
   Some such adjustments may be made either in the process for generating the representative set of reference vectors; in the process for testing test vectors; or both.

In some cases, a system according to the invention may wrongly pass objects which should fail. Such objects may be called “false positives”. In such a case, either a new set of representative reference vectors may be generated or one or more parameters of the system may be adjusted to cause the false positives to fail. Where a new set of representative reference vectors is generated, the new set may be generated from a different selection of “good” images, the parameters used in generating the representative reference vectors may be altered, or both.

The methods and apparatus of the invention may be applied to classifying defects as well as to identifying the existence of defects. Defect classification may be performed by developing sets of reference vectors which correspond to defects of different types. One set of reference vectors is provided for each type of defect. A set of defect reference vectors may be generated as described above except that instead of using displays identified as being “good” the set of reference vectors is built using images of displays which have been identified as having a particular type of defect. The displays used to build a set of defect reference vectors may have been identified by human expert observers as possessing the defect.

Test vectors identified as possibly indicating defects may be compared to one or more sets of defect reference vectors each corresponding to a different type of defect. The defect may be classified by identifying the set of defect reference vectors to which the test vectors are most similar.

The invention is not limited to use with the simple example test vectors described above. In general, each test vector and each reference vector has two parts, a spatial part and a characteristic part. The spatial parts contains coordinates (e.g. X and Y) which indicate a spatial location to which the vector corresponds. The characteristic part contains one or more components indicative of a characteristic corresponding to the location identified by the spatial part.

The characteristic part may contain any suitable combination of detected characteristics. These may include characteristics such as:
color values;
intensities;
color values corresponding to the same point on an object being tested but detected by different sensors (e.g. color values detected by both camera 26 and one or more cameras 26A in apparatus 24 of FIG. 2);
an identification of the signal being given to the display being tested (e.g. what color and/or pattern is being displayed on the display being tested)
relationships between a characteristic corresponding to the location specified by the spatial part of the vector and characteristics corresponding to adjacent locations, for example:
characteristic values for one or more adjacent pixels;
average characteristic values for a block of pixels corresponding to the location;
differences or ratios between a characteristic value corresponding to the location and corresponding characteristic values corresponding to one or more adjacent locations;
spatial Fourier transforms of pixel characteristics centered on individual pixels (Fourier transforms can identify pixels having characteristics that differ significantly from their neighbors);
contrast of a pixel (e.g. the difference between an intensity of the pixel for one color and an average intensity of pixels either in a surrounding region or in the display as a whole;

or the difference in a computed normalized overall intensity of the pixel and an average normalized overall intensity of pixels either in a surrounding region or in the display as a whole); and,
information about averages of one or more characteristics of a block of pixels (for example a 3×3 block of 9 pixels); and,
moiré spatial phase in cases where moiré patterns exist.
   These characteristics can be categorized into a number of categories including: raw data (e.g. RGB values generated by a camera 26); contextual information (e.g. what is being displayed on the display being tested); correlated information (e.g. what color is being displayed on a pixel at a specific location on the display being tested) and calculated information (e.g. a normalized intensity reading for a location on the display).

One advantage that may be achieved in systems according to the invention, especially those which use test vectors containing characteristics of a group of pixels, is the ability to suppress moiré pattern effects. Moiré patterns which result from interactions between the fill pattern of pixels in a display and the fill pattern of light sensors in a CCD array can be captured by a CCD array. Where such a moiré pattern is captured, the intensity of light detected in any pixel of the CCD array will depend in part on the spatial phase of the pixel in relation to the moiré pattern. Where each test vector includes characteristic information, such as RGB values, for some surrounding pixels, the effect of moiré patterns is reduced. Moire pattern effects are reduced where the methods of this invention preferentially identify nearest neighbor reference vectors having the same moiré spatial phase as the test vector. In some embodiments of the invention, the moiré spatial phase is calculated and included as a characteristic in the test and reference vectors.

Certain implementations of the invention comprise computer processors which execute software instructions which cause the processors to perform a method of the invention. For example, one or more processors in a system according to the invention may implement the methods of any of FIGS. 3, 4, 4A, 4C, 5 or 7 by executing software instructions in a program memory accessible to the processors. The processors may comprise microprocessors or any other suitable data processing devices. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links. The computer-readable signals may optionally be encrypted and/or compressed using any suitable encryption and/or compression technology.

In embodiments of the invention which include one or more data processors which execute software instructions, the software instructions may be organized in any suitable manner. For example, the software instructions may be organized into objects, routines, subroutines which cause the data processors perform steps in any of the methods described herein.

In some embodiments of the invention, some or all data processing is performed by hardware logic circuits configured to perform various steps in the methods set out herein.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
the spatial parts of test and reference vectors do not need to have as components coordinates in a Cartesian coordinate system. The spatial parts could include coordinates in other coordinate systems such as polar coordinate systems. Where the sensor used to acquire the image data comprises a digital camera having an array of light sensors, a Cartesian coordinate system is typically most convenient;
The sensor(s) used to acquire image data are not necessarily sensitive to visible light. Any sensor or combinations of sensor which produces an image in 2 or 3 dimensions may be used. For example, scanner 12 could comprise one or more of: a 2 or 3-dimensional ultrasound imaging device; a magnetic resonance imaging (MRI) system; an X-ray imaging system a computed tomography (CT) scanner; an infrared camera; an electric field sensor or the like. Each of these systems is capable of producing image data which specifies one or more measured characteristics for pixels or voxels which make up a 2 or 3-dimensional image of an object being tested.
The invention is not limited to situations wherein each vector corresponds to a two-dimensional spatial location. Scanner 12 may obtain characteristic data from a range of locations in 2 or 3 dimensions.
The foregoing description describes some methods of the invention as processing vectors sequentially until all of the vectors have been processed. In general, this is not necessary. In a computer system having sufficient capacity, multiple vectors could be processed in parallel.
   Accordingly, the scope of the invention is to be construed in accordance with the substance defined by the following claims.

1. A method for detecting defects in electronic displays, the method comprising:
providing image data for a test display, the image data comprising values for one or more characteristics of the test display as a function of spatial position on the test display and a set of reference vectors, the reference vectors generated from reference image data of one or more reference displays known to be good;
generating from the image data a plurality of test vectors, each of the test vectors having a spatial part corresponding to a spatial position on the test display and a characteristic part;
for each of the test vectors: identifying a subset of the set of reference vectors based upon at least the spatial part of the test vector; and, determining a degree of similarity between the test vector and one or more reference vectors of the subset of the set of reference vectors; and,
identifying any of the test vectors for which the degree of similarity fails to satisfy a similarity criterion.

2. A method according to claim 1 wherein the set of reference vectors comprises reference vectors generated from images of each of a plurality of reference displays known to be good.

3. A method according to claim 2 wherein the set of reference vectors comprises a representative set of reference vectors obtained by generating an initial set of reference vectors from the images of each of the plurality of reference displays known to be good and selecting a representative set of the initial set of reference vectors.

4. A method according to claim 3 wherein selecting the representative set comprises selecting not more than 40% of the reference vectors of the initial set of reference vectors.

5. A method according to claim 3 wherein identifying a subset of the set of reference vectors comprises identifying a cluster associated with a subset of the set of reference vectors; and, determining a degree of similarity between the test vector and one or more reference vectors of the subset of the set of reference vectors comprises based upon both the spatial and characteristic parts of the test vector, identifying within the subset of the reference vectors a number, k, of nearest-neighbor reference vectors; and, determining a degree of similarity between the test vector and the nearest-neighbor reference vectors.

6. A method according to claim 3 wherein the set of reference vectors comprises a representative set of reference vectors obtained by:
a) taking a subset of the initial set of reference vectors, the subset including a desired number of the reference vectors;
b) comparing the reference vectors in the subset to one another;
c) identifying a pair of the reference vectors in the subset that are most similar to one another;
d) removing one of the pair of most similar reference vectors from the subset;
e) adding a next one of the initial set of reference vectors to the subset; and,
f) repeating steps (c) and (d) until the initial set of reference vectors has been processed.

7. A method according to claim 6 wherein removing one of the pair of most similar reference vectors comprises removing the one of the most similar pair that has the greatest similarity similar to any reference vector in the subset other than the other one of the most similar pair.

8. A method according to claim 6 wherein the method comprises rejecting any of the reference vectors for which there are not a plurality of nearest-neighbor other ones of the reference vectors that are closer than a threshold distance to the reference vector.

9. A method according to claim 6 comprising, after comparing the reference vectors in the subset to one another, eliminating from the subset any reference vectors which are not within a threshold distance of at least some predetermined number of other reference vectors in the subset.

10. A method according to claim 3 wherein the set of reference vectors comprises a representative set of reference vectors obtained by:
generating an initial set of reference vectors from the images of each of the plurality of reference displays known to be good;
for each of the reference vectors in the initial set of reference vectors:
identifying a plurality of nearest-neighbor other ones of the reference vectors which are nearest to the reference vector;
computing an average of the nearest-neighbor reference vectors;
computing a distance between the reference vector and the average vector; and,
selecting those of the reference vectors for which the distance between the reference vector and the average vector is greatest.

11. A method according to claim 10 wherein all of the plurality of nearest-neighbor other ones of the reference vectors are closer than a threshold distance to the reference vector according to a distance metric wherein the method comprises rejecting any of the reference vectors for which there are not a plurality of nearest-neighbor other ones of the reference vectors that are closer than the threshold distance to the reference vector.

12. A method according to claim 11 comprising:
failing one or more test vectors corresponding to a display;
determining that the display is good; and,
subsequently regenerating the representative set of reference vectors by including reference vectors generated from an image of the good display in the initial set of reference vectors.

13. A method according to claim 3 wherein the set of reference vectors comprises a representative set of reference vectors obtained by:
generating an initial set of reference vectors from the image of the at least one reference display known to be good;
for each of the reference vectors in the initial set of reference vectors:
identifying a plurality of nearest-neighbor other ones of the reference vectors which are nearest to the reference vector;
computing an average of the nearest-neighbor reference vectors;
computing a distance between the reference vector and the average vector; and,
selecting those of the reference vectors for which the distance between the reference vector and the average vector is greatest.

14. A method according to claim 13 wherein all of the plurality of nearest-neighbor other ones of the reference vectors are closer than a threshold distance to the reference vector according to a distance metric wherein the method comprises rejecting any of the reference vectors for which there are not a plurality of nearest-neighbor other ones of the reference vectors that are closer than the threshold distance to the reference vector.

15. A method according to claim 3 comprising selecting a number, N, of reference vectors for inclusion in the representative set of reference vectors wherein N is determined based upon a user input.

16. A method according to claim 3 comprising:
failing one or more test vectors corresponding to an display;
determining that the display is good; and,
subsequently regenerating the representative set of reference vectors by including reference vectors generated from an image of the good display in the initial set of reference vectors.

17. A method according to claim 1 comprising classifying the test vectors into a plurality of clusters and comparing the test vectors of each of the clusters to a different set of reference vectors.

18. A method according to claim 17 wherein each of the clusters corresponds to a spatial area of the image and classifying the test vectors into the clusters comprises assigning to each cluster those of the test vectors having spatial parts corresponding to the spatial area corresponding to the cluster.

19. A method according to claim 18 wherein the spatial areas are rectangular areas.

20. A method according to claim 18 wherein each of the areas overlaps with one or more adjacent ones of the areas.

21. A method according to claim 18 wherein the set of reference vectors corresponding to each of the clusters comprises a set of reference vectors which includes reference vectors having spatial parts corresponding to locations outside of the area corresponding to the cluster.

22. A method according to claim 21 comprising providing for each of the clusters a group of reference vectors having spatial parts corresponding to areas corresponding to locations in the area corresponding to the cluster, the method comprising assembling the set of reference vectors corresponding to each of the clusters by taking a union of the group of reference vectors provided for the cluster with groups of reference vectors provided for one or more clusters adjacent to the cluster.

23. A method according to claim 18 comprising displaying a test pattern on the test display while acquiring the image data by taking a digital photograph of the test display.

24. A method according to claim 23 wherein the test pattern comprises a uniform image.

25. A method according to claim 1 wherein identifying a subset of the set of reference vectors comprises, based upon at least the spatial part of the test vector, identifying a cluster associated with a subset of the set of reference vectors; and wherein determining the degree of similarity between the test vector and one or more reference vectors comprises subsequently, based upon both the spatial and characteristic parts of the test vector, identifying within the subset of the reference vectors a number, k, of nearest-neighbor reference vectors.

26. A method according to claim 25 wherein obtaining the image data comprises taking a digital photograph of the test display.

27. A method according to claim 26 comprising displaying a test pattern on the test display while taking the digital photograph.

28. A method according to claim 27 wherein the test pattern comprises a uniform image.

29. A method according to claim 25 wherein identifying a cluster associated with a subset of the set of reference vectors comprises maintaining an association between a plurality of areas within the image data and a corresponding plurality of subsets of the reference vectors and identifying one of the plurality of areas containing a pixel identified by the spatial part of the test vector.

30. A method according to claim 29 wherein the plurality of areas are rectangular areas.

31. A method according to claim 25 wherein determining the degree of similarity between the test vector and the nearest-neighbor reference vectors comprises computing a predicted vector by averaging the nearest-neighbor reference vectors and computing a distance between the test vector and the predicted vector according to a distance metric which depends upon both the spatial and characteristic parts of the test and predicted vectors.

32. A method according to claim 1 wherein determining the degree of similarity comprises identifying a number of nearest-neighbor reference vectors in the subset of reference vectors, the nearest-neighbor reference vectors being closest to the test vector according to a first distance metric, generating a predicted vector by computing an average of the nearest-neighbor reference vectors, and comparing the test vector to the predicted vector.

33. A method according to claim 32 wherein comparing the test vector to the predicted vector comprises computing a distance between the test vector and the predicted vector according to a second distance metric.

34. A method according to claim 33 wherein the first and second distance metrics are different from one another.

35. A method according to claim 33 wherein the first and second distance metrics are the same as one another.

36. A method according to claim 33 wherein the test and reference vectors each comprise a plurality of components Vᵢ and the second distance metric is based upon differences between the components of the test vector and the corresponding components of the predicted vector.

37. A method according to claim 36 wherein the first distance metric is of the form:
$$S = {\sum }_{i} {f}_{i} ( {W}_{i} , Δ {V}_{i} )$$
where S is a difference according to the distance metric, i is an index having a values which identify the components of the test and predicted vectors, Wᵢ are weighting coefficients; ΔVᵢ is the difference between the i^{th} components of the test predicted vectors and fᵢ are comparison functions.

38. A method according to claim 37 wherein at least some of the weighting coefficients are based upon a measure of variance in the corresponding component of the reference vector in the set of reference vectors.

39. A method according to claim 38 wherein the measure of variation is a standard deviation of the component in the reference vectors.

40. A method according to claim 38 wherein the measure of variation is a range of the component in the reference vectors.

41. A method according to claim 38 wherein the measure of variation is a variance of the component in the reference vectors.

42. A method according to claim 37 wherein the first distance metric is of the form:
$$S = {\sum }_{i} {W}_{i} Δ {V}_{i}^{2} .$$

43. A method according to claim 37 wherein the first distance metric is of the form:
$$S = {\sum }_{i} {W}_{i} \vert Δ {V}_{i} \vert .$$

44. A method according to claim 37 wherein the first and second distance metrics are of the same form and differ in the values for the weighting coefficients Wᵢ.

45. A method according to claim 37 wherein a plurality of the components of the test and predicted vectors are in the spatial parts of the test and predicted vectors and a plurality of the components of the test and predicted vectors are in the characteristic parts of the test and predicted vectors.

46. A method according to claim 45 wherein, in the first distance metric, the weighting factors corresponding to the components in the spatial part are larger than the weighting factors corresponding to the components in the characteristic part.

47. A method according to claim 33 wherein determining a degree of similarity between each of the test vectors and the reference vectors comprises determining a health index, SH, for each of the test vectors the health index given by:
$$SH = \frac{SSim - SSM}{1 - SSM} when SSim > SSM$$
$$and by \text{:}$$
$$SH = \frac{SSim - SSM}{SStd} when SSim \leq SSM$$
or a mathematical equivalent thereof, where SSim is a distance between the selected test vector and the predicted vector according to the second distance metric; SSM is an average similarity of the test vectors which is normalized so that 0<SSM≦1; and SStd is the standard deviation of the similarities of the reference vectors.

48. A method according to claim 33 comprising triggering an alarm condition if a component of the predicted vector and a corresponding component of the test vector differ by an amount which is greater than a threshold.

49. A method according to claim 33 comprising triggering an alarm condition if a distance between the predicted vector and the test vector is greater than a threshold.

50. A method according to claim 33 comprising triggering an alarm condition if a distance between the predicted vector and the test vector is less than a threshold.

51. A method according to claim 33 comprising making a map showing distance between the test and predicted vectors as a function of spatial coordinates in the spatial parts of the test vectors.

52. A method according to claim 1 wherein the image comprises a digital photograph of the test display.

53. A method according to claim 52 wherein the test and reference vectors each comprise in their characteristic parts components indicating levels of a plurality of colors.

54. A method according to claim 52 comprising displaying an image on the display and taking the digital photograph of the display while the image is displayed on the display.

55. A method according to claim 54 wherein displaying the image on the display comprises displaying a uniform image on the display.

56. A method according to claim 55 wherein the uniform image comprises a plurality of colors.

57. A method according to claim 52 wherein the image comprises data regarding characteristics of the display corresponding to each pixel in an array of contiguous pixels.

58. A method according to claim 57 wherein the characteristic parts of the test and reference vectors each comprise a component corresponding to a characteristic of a pixel and one or more other components corresponding to one or more other pixels adjacent to the pixel.

59. A method according to claim 57 wherein the characteristic parts of the test and reference vectors each comprise a component containing a value which is a function of characteristics of two or more pixels.

60. A method according to claim 59 wherein the function comprises a Fourier transform.

61. A method according to claim 57 wherein the characteristic parts of the test and reference vectors each comprise a component containing a value which is an average of characteristics of two or more pixels.

62. A method according to claim 57 wherein the characteristic parts of the test and reference vectors each comprise a component containing a value which is representative of a normalized light intensity corresponding to a pixel.

63. A method according to claim 1 wherein the similarity criterion is based upon a distance between the test and reference vectors according to a metric, wherein the metric is defined at least in part by a statistical property of the set of reference vectors.

64. A method according to claim 63 wherein the statistical property is a measure of variance of a component of the reference vectors.

65. A method according to claim 64 wherein the metric is of the form:
$$S = {\sum }_{i} {f}_{i} ( {W}_{i} , Δ {V}_{i} )$$
where S is a distance according to the metric, i is an index having a values which identify the components of the test and reference vectors, Wᵢ are weighting coefficients; ΔVᵢ is the difference between the i^{th} components of the test predicted vectors and fᵢ are comparison functions wherein at least some of the weighting coefficients are based upon the measure of variance in the corresponding component of the reference vector in the set of reference vectors.

66. A method for detecting defects in electronic displays, the method comprising:
providing image data for a test display, the image data comprising values for one or more characteristics of the test display as a function of spatial position on the test display and a set of reference vectors, the reference vectors generated from reference image data of one or more reference displays known to be good;
generating from the image data a plurality of test vectors,
for each of the test vectors: determining a degree of similarity between the test vector and a vector derived from one or more reference vectors of the set of reference vectors based upon a distance between the test and reference vectors according to a metric, wherein the metric is defined at least in part by a statistical property of the set of reference vectors.

67. A method according to claim 66 wherein each of the test vectors has a spatial part corresponding to a spatial position on the test display and a characteristic part.

68. A method according to claim 67 wherein the statistical property is a measure of variance of a component of the reference vectors.

69. A method according to claim 68 wherein the metric is of the form:
$$S = {\sum }_{i} {f}_{i} ( {W}_{i} , Δ {V}_{i} )$$
where S is a distance according to the metric, i is an index having a values which identify the components of the test and reference vectors, Wᵢ are weighting coefficients; ΔVᵢ is the difference between the i^{th} components of the test predicted vectors and fᵢ are comparison functions wherein at least some of the weighting coefficients are based upon the measure of variance in the corresponding component of the reference vector in the set of reference vectors.

70. A method according to claim 66 comprising determining a health index for each of the test vectors, the health index based upon both a distance between the test vector and at least one of the reference vectors or a vector derived from one or more of the reference vectors and a measure of a statistical distribution of a similarity of the reference vectors to one another.

71. A method according to claim 70 wherein the health index is computed according to:
$$SH = \frac{SSim - SSM}{1 - SSM} when SSim > SSM$$
$$and by \text{:}$$
$$SH = \frac{SSim - SSM}{SStd} when SSim \leq SSM$$
or mathematical equivalents thereof, where SSim is a distance between the selected test vector and the predicted vector according to a distance metric; SSM is an average similarity of the test vectors which is normalized so that 0<SSM≦1; and SStd is a measure of variance in the similarities of the reference vectors to one another.

72. A method according to claim 71 wherein SStd is a standard deviation.

73. A method for generating a reduced set of reference vectors from one or more sets of reference image data for use in testing electronic displays, the method comprising:
providing an initial set of reference vectors derived from one or more sets of reference image data;
selecting from the initial set of reference vectors a reduced set of reference vectors based upon similarities of the reference vectors to one another.

74. A method according to claim 73 wherein each of the reference vectors comprises a spatial part and a characteristic part.

75. A method according to claim 74 comprising grouping the reference vectors into a plurality of clusters and selecting a separate reduced set of reference vectors from the reference vectors in each of the clusters;
wherein grouping the reference vectors into the plurality of clusters comprises associating with each of the clusters a spatial area and assigning to the cluster only reference vectors for which the spatial part identifies a spatial location within the area.

76. A method according to claim 75 wherein selecting the separate reduced set of reference vectors from the reference vectors in each of the clusters comprises selecting reference vectors that are farthest from an average of a plurality of other reference vectors that are nearest neighbors to the selected reference vectors.

77. A method according to claim 75 wherein grouping the reference vectors into the plurality of clusters comprises associating with each of the clusters a spatial area and a characteristic or combination of characteristics and assigning to the cluster only reference vectors for which the spatial part identifies a spatial location within the area and the characteristic part includes the characteristic or combination of characteristics.

78. A program product comprising a medium carrying a set of computer-readable signals, the signals comprising instructions which, when executed by a data processor, cause the data processor to execute a method according to claim 1.

79. Apparatus for automatic detection of defects in electronic displays, the apparatus comprising:
a data processor; and,
a data store accessible to the data processor and capable of storing image data for a test display, the image data comprising values for one or more characteristics of the test display as a function of spatial position on the test display and a set of reference vectors generated from reference image data of one or more reference displays known to be good;
a program memory containing software instructions which cause the data processor to:
retrieve from the data store image data for a test display;
generate from the image data a plurality of test vectors, each of the test vectors having a spatial part corresponding to a spatial position on the test display and a characteristic part;
for each of the test vectors: identify a subset of the set of reference vectors based upon at least the spatial part of the test vector; and, determine a degree of similarity between the test vector and one or more reference vectors of the subset of the set of reference vectors; and,
identify any of the test vectors for which the degree of similarity fails to satisfy a similarity criterion.

80. Apparatus according to claim 79 comprising a digital camera connected to acquire the image data.

81. Apparatus according to claim 80 comprising a display driver connected to drive the display with a test pattern during acquisition of the image data by the digital camera.

82. Apparatus for automatic detection of defects in electronic displays, the apparatus comprising:
imaging means for obtaining image data for a test display, the image data comprising values for one or more characteristics of the test display as a function of spatial position on the test display;
reference vector storage means providing a set of reference vectors generated from reference image data of one or more reference displays known to be good;
test vector generating means for generating from image data for a test display a plurality of test vectors, each of the test vectors having a spatial part corresponding to a spatial position on the test display and a characteristic part;
reference vector selecting means for identifying a subset of the set of reference vectors corresponding to a test vector generated by the test vector generating means based upon at least the spatial part of the test vector; and,
vector comparison means for determining a degree of similarity between a test vector and one or more reference vectors of the subset of the set of reference vectors identified by the reference vector selecting means; and,
means for identifying any of the test vectors for which the degree of similarity determined by the vector comparison means fails to satisfy a similarity criterion.
